(19) United States
(12) Patent Application Publication
(10) Pub. No.: US 2010/0051650 A1
(43) Pub. Date: Mar. 4, 2010

(54) Spray gun for generating continuous spray and method for controlling the spray gun

(75) Inventor: Lee-Wei Chou, Taipei County (TW)

Correspondence Address: LEE-WEI CHOU, P.O.Box 44-2049, Taipei, 10668, TW

(73) Assignee: Pearl Ocean International Limited

(21) Appl. No.: 12/230,635

(22) Filed: Sep. 3, 2008

(51) Int. Cl. B67D 7/58

(52) U.S. Cl. 222/383.1

(57) ABSTRACT

A spray gun includes a spray unit, the spray unit having a nozzle and a trigger connected beneath the nozzle, a frame connected to the spray unit and connected with a container, and a path defined between the nozzle and the frame; a sliding slope having a slope sliding by driving the trigger, further having a return unit at the back end to drive the trigger back to original position after the trigger is pulled; an action rod having a piston at one end thereof and the slope of the sliding slope at another end thereof, the piston is moved reciprocally by the slope of the sliding slope when the trigger is pushed and returned to original position, and a pump connected to the path and the action rod is located corresponding to the pump, the action rod located within the pump and defining the pump into a first chamber and a second chamber; wherein when the piston is moved reciprocally by the slope of the sliding slope, the first chamber and the second chamber output liquid alternatively to generate the continuous spray.

### BACKGROUND OF THE INVENTION

(1) Field of the Invention

The present invention relates to a spry gun, and more particularly, to a spray gun that the liquid is sprayed continuously during both back and forth movements of the trigger.

(2) Description of the Prior Art

A conventional spry gun is shown in FIG. 1 and can only spray discontinuous liquid from the container by pulling the trigger, when the trigger moves back, no liquid can be sent out from the spray gun. When a large amount of liquid is needed, the user has to continuously press and release and then press the trigger. This way can generate the spray discontinuously because there is no spray when the trigger is released. The user can easily feel tired by the continuous actions.

The present invention intends to provide a spray gun that uses mechanical way to generate continuous sprays when the trigger is pulled and released.

### SUMMARY OF THE INVENTION

The present invention relates to a spray gun which comprises a spray unit having a nozzle and a trigger connected beneath the nozzle. A frame is connected to the spray unit and connected with a container. A path is defined between the nozzle and the frame. A sliding slope has a slope sliding by driving the trigger. Further, the sliding slope having a return unit drives the trigger back to original position after the trigger is pulled. An action rod has a piston at one end thereof and the slope at another end thereof. The piston is moved reciprocally by the slope of the sliding slope when the trigger is pushed and returned to original position. A pump is connected to the passage and the action rod is located corresponding to the pump. The action rod is located within the pump and defines the pump into a first chamber and a second chamber. When the piston is moved reciprocally by the slope of the sliding slope, the first chamber and the second chamber output liquid alternatively to generate the continuous spray.

The present invention further provides a method for controlling a spray gun and the method comprises step a: a piston of an action rod moving reciprocally following the movement of a sliding slope when the trigger is pushed and returned, step b: the action rod located corresponding to the pump and a force caused by the reciprocal action of the piston of the action rod applying to the pump with the first and second chambers, and step c: the nozzle connected with the pump and generating continuous spray when the trigger is pushed and returned, the first chamber and second chamber generating continuous spray alternatively when the piston moves back and forth.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional spray gun;

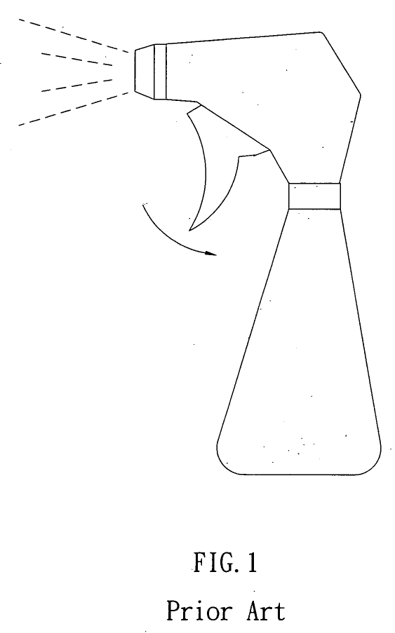

FIG. 2 shows the spray gun of the present invention;

FIG. 3 shows the main parts of the spray gun of the present invention;

FIGS. 4a and 4b show the actions of the pump of the spray gun of the present invention, and

FIG. 5 shows the flow chart of the method for controlling the spray gun of the present invention.

### DETAILED DESCRIPTION OF THE PREFERRED EMBODIMENTS

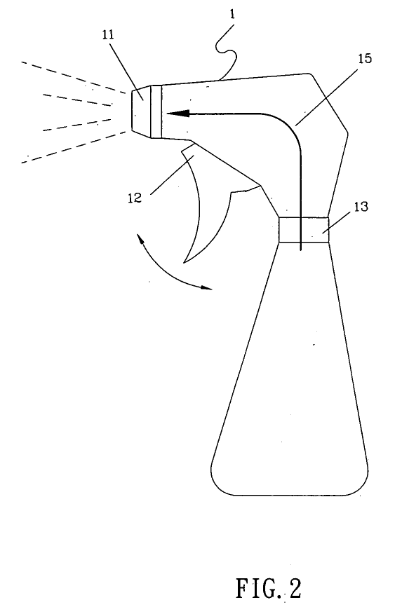

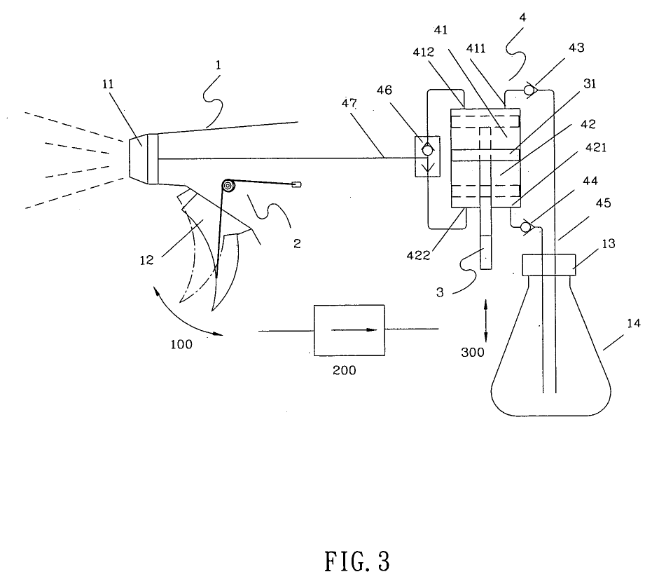

The present invention may best be understood by reference to the following description in conjunction with the accompanying drawings from FIG. 2-FIG. 5.

Referring to FIGS. 2 to 4b, the spray gun of the present invention comprises a spray unit 1 having a nozzle 11 and a trigger 12 is connected beneath the nozzle 11. A frame 13 is connected to the spray unit 1 and a container 14 is connected with the frame 13. A path 15 is defined between the nozzle 11 and the frame 13. A sliding slope 2 having a slope 21 is slid by driving the trigger 12. The sliding slope 2 having a return unit 22 at the back end to drive the trigger 12 back to original position after the trigger is pulled. An action rod 3 has a piston 31 at one end thereof and the slope 21 of the sliding slope 2 at another end thereof which performs a reciprocal action 300 by the movement of the sliding slope 200 when the trigger 12 is pushed and returned 100. A pump 4 is connected to the passage 15 and the action rod 3 is located corresponding to the pump 4. The action rod 3 is located within the pump 4 and defines the pump 4 into a first chamber 41 and a second chamber 42. When the piston 31 moves reciprocally by the slope 21 of the sliding slope 2, the first chamber 41 and the second chamber 42 output liquid alternatively to generate the continuous spray.

Further, the first chamber 41 includes a first inlet 411 and a first outlet 412, the second chamber 42 includes a second inlet 421 and a second outlet 422. The first and second outlets 412, 422 are connected with a switch valve 47 which connected with an outlet pipe 48. The nozzle 11 is connected to the outlet pipe 48 to switch open/close. Two respective inlet pipes 45, 46 are connected to the first and second inlets 411, 421, and two respective one-way valves 43, 44 are located in the two inlet pipes 45, 46 to prevent the reserved flow. It is noted that a single inlet pipe (not shown) can be connected to the two respective one-way valves 43, 44.

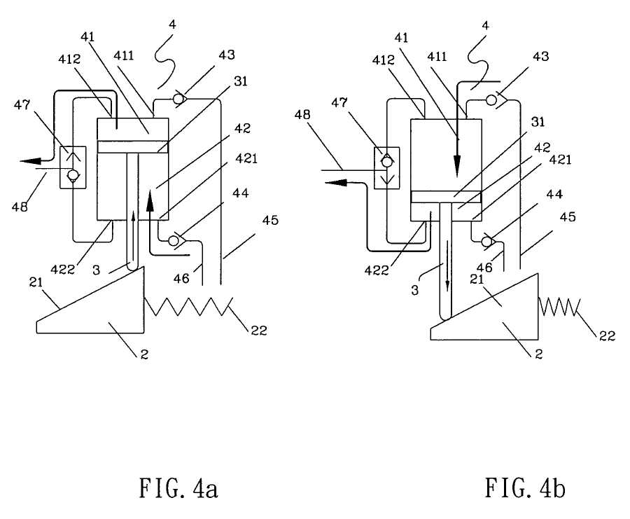

As shown in FIGS. 4a and 4b, when the action rod 3 moves upward, the piston 31 moves upward to narrow the first chamber 41. The one-way valve 43 seals the first inlet 411 and the first outlet 412 communicates with the outlet pipe 48 by the operation of the switch valve 47, so that the liquid is outputted from the outlet pipe 48. The second chamber 42 becomes larger and the second outlet 422 is sealed by the operation of the switch valve 471 and the one-way valve 44 of the second inlet 421 is opened. The liquid enters into the second chamber 42 via the inlet pipe 46. This performs the alternative output of the liquid. As shown in FIG. 4b, when the action rod 3 moves downward, the piston 31 moves downward to narrow the second chamber 42. The one-way valve 44 seals the second inlet 421 and the second outlet 422 communicates with the outlet pipe 48 by the operation of the switch valve 47, so that the liquid is outputted from the outlet pipe 48. The first chamber 41 becomes larger and the first outlet 412 is sealed by the operation of the switch valve 471 and the one-way valve 43 of the first inlet 411 is opened. The liquid enters into the first chamber 41 via the inlet pipe 45. This performs the alternative output of the liquid.

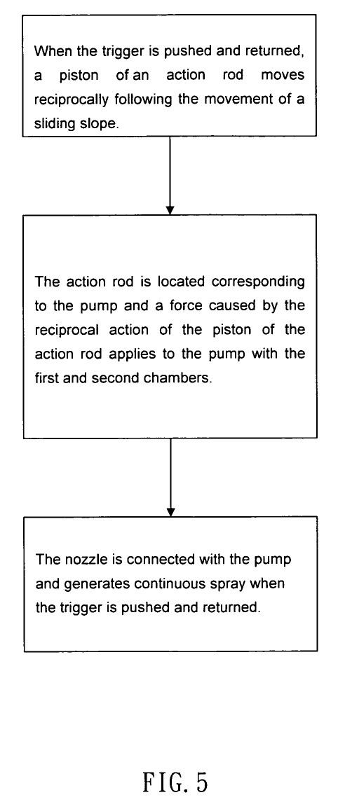

As shown in FIG. 5 shows the flow chart of the method for controlling the spray gun, the following description in conjunction with the accompanying drawings from FIG. 2-FIG. 4b, the method comprises the following steps:

step a: a piston 31 of an action rod 3 moving reciprocally following the movement of a sliding slope 200 when the trigger 12 is pushed and returned 100;

step b: the action rod 3 located corresponding to the pump 4 and a force caused by the reciprocal action 300 of the piston 31 of the action rod 3 applying to the pump 4 with the first and second chambers 41,42, and

step c: the nozzle 11 connected with the pump 4 and generating continuous spray when the trigger is pushed and returned 100. The action rod 3 is moved following the movement of the sliding slope 2. The first chamber 41 and the second chamber 42 output liquid alternatively to generate the continuous spray, when the piston moves reciprocally.

While we have shown and described the embodiment in accordance with the present invention, it should be clear to those skilled in the art that further embodiments may be made without departing from the scope of the present invention.

What is claimed is:

1. A spray gun comprising:
a spray unit having a nozzle and a trigger connected beneath the nozzle, a frame connected to the spray unit and connected with a container, and a path defined between the nozzle and the frame;
a sliding slope having a slope sliding by driving the trigger, further having a return unit at the back end to drive the trigger back to original position after the trigger is pulled;
an action rod having a piston at one end thereof and the slope of the sliding slope at another end thereof, the piston is moved reciprocally by the slope of the sliding slope when the trigger is pushed and returned to original position, and
a pump connected to the path and the action rod is located corresponding to the pump, the action rod located within the pump and defining the pump into a first chamber and a second chamber;
wherein when the piston is moved reciprocally by the slope of the sliding slope, the first chamber and the second chamber output liquid alternatively to generate the continuous spray.

2. The spray gun as claimed in claim 1, wherein the first chamber includes a first inlet and a first outlet, the second chamber includes a second inlet and a second outlet.

3. The spray gun as claimed in claim 2, wherein the first and second outlets are connected with a switch valve, and the switch valve connected with an outlet pipe, the nozzle is connected to the outlet pipe to switch open/close.

4. The spray gun as claimed in claim 2, wherein front ends of the first inlet and the second inlet having inlet pipes respectively, and two respective one-way valves are located respectively in the two inlet pipes.

5. The spray gun as claimed in claim 4, wherein a single inlet pipe is connected to the two respective one-way valves.

6. A method for controlling a spray gun, the spray gun includes a frame connected to the spray unit and connected with a container, a spray unit with a nozzle and a trigger connected beneath the nozzle, a return unit connected to the spray unit and driving the trigger back to original position after the trigger is pulled, the method comprising:
step a: a piston of an action rod moving reciprocally following the movement of a sliding slope when the trigger is pushed and returned;
step b: the action rod located corresponding to the pump and a force caused by the reciprocal action of the piston of the action rod applying to the pump with the first and second chambers, and
step c: the nozzle connected with the pump and generating continuous spray;
wherein the action rod moving following the movement of the sliding slope, the first chamber and the second chamber output liquid alternatively to generate the continuous spray, when the piston moves reciprocally.

7. The method as claimed in claim 6, wherein the first chamber includes a first inlet and a first outlet, the second chamber includes a second inlet and a second outlet.

8. The method as claimed in claim 7, wherein the first and second outlets are connected with a switch valve which communicates with an outlet pipe, the nozzle is connected to the outlet pipe.

9. The method as claimed in claim 7, wherein two respective inlet pipes are connected to the first and second inlets, and two respective one-way valves are located in the two inlet pipes.

10. The method as claimed in claim 9, wherein a single inlet pipe is connected to the two respective one-way valves.
